(19) United States
(12) Patent Application Publication
(10) Pub. No.: US 2012/0177941 A1
(43) Pub. Date: Jul. 12, 2012

(54) Multilayer armor and method of manufacture thereof

(76) Inventors: Bradley W. Peterson, Kensington, MD (US); David C. Eyvazzadeh, College Park, MD (US); James Jerome Holton, Alexandria, VA (US); Adam Jay Harrison, Herndon, VA (US)

(21) Appl. No.: 12/068,591

(22) Filed: Feb. 8, 2008

Related U.S. Application Data
(60) Provisional application No. 60/935,162, filed on Jul. 30, 2007.
(60) Provisional application No. 60/996,228, filed on Nov. 7, 2007.

(51) Int. Cl. F41H 5/04; B32B 37/14; B32B 7/02; B32B 15/01; B32B 15/08

(52) U.S. Cl. 428/593; 428/323; 428/329; 428/331; 428/328; 428/188; 156/60

(57) ABSTRACT

Multilayer armor includes an outside armor layer, a first armor layer underneath the outside armor layer, a second armor layer underneath the first armor layer, and a truss layer underneath the second armor layer. In another variation, the multilayer armor includes an outside armor layer, a composite layer underneath the outside armor layer that comprises a plurality of spheres, a second armor layer underneath the composite layer to provide a rigid support to the composite layer, and a third armor layer underneath the second armor layer. The second layer may comprise a composite material that includes a plurality of tightly nested layers in a self-assembling arrangement of spheres made of a high hardness material bonded together using a matrix.

This application claims the benefit of provisional patent applications No. 60/935,162, filed on Jul. 30, 2007, and provisional patent application No.60/996,228, filed on Nov. 7, 2007, and having Attorney Docket No. 029768-00006. The contents of both provisional applications are herein incorporated by reference in their entirety.

### BACKGROUND OF THE INVENTION

1. Field of the Invention

The present invention is directed to an armor panel, and in particular to multilayer armor having a composite layer, a truss layer, and one or more layers comprising metal alloys.

2. Description of the Related Art

There are generally three main considerations concerning protective armor panels. The first consideration is weight and bulk. Protective armor for heavy but mobile military equipment, such as tanks and large ships, is known. Such armor usually comprises a thick layer of alloy steel, which is intended to provide protection against heavy and explosive projectiles such as small arms, mines and improvised explosive devices, which can pose a severe threat, especially to light armored vehicles. Due to its weight, such armor is not suitable for light vehicles, such as automobiles, jeeps, light boats, or aircraft, the performance of which would likely be compromised by steel panels having a thickness of more than a few millimeters. Armor for vehicles, including land, airborne and amphibious vehicles, is expected to prevent penetration of bullets of any weight, even when impacting at a speed in the range of 700 to 1000 meters per second. The maximum armor weight that is acceptable for use on light vehicles varies with the type of vehicle, but generally falls in the range of 40 to 100 kg/m².

A second consideration is cost. Overly complex armor arrangements, particularly those depending entirely on synthetic fibers, can be responsible for a notable proportion of the total vehicle cost, and can make its manufacture non-profitable.

A third consideration is robustness of the armor package. Further, ceramic materials, which are nonmetallic, inorganic solids having a crystalline or glassy structure, have many useful physical properties, including resistance to heat, abrasion and compression, high rigidity, low weight in comparison with steel, and outstanding chemical stability, have long drawn the attention of armor designers, and solid ceramic plates, in thicknesses ranging from 3 mm for personal protection to 50 mm for heavy military vehicles, are commercially available for such use. However, a common problem with existing ceramic armor concerns damage inflicted on the armor structure by a first projectile, (e.g., shattering) whether stopped or penetrating. Furthermore, none of these designs is configured to mitigate damage from a blast wave. In explosive devices, the blast wave acts in concert with the projectile itself, and creates additional damage. Such damage weakens the armor panel, and so allows penetration of a following projectile, for example, impacting within a few centimeters of the first.

Other examples of armor systems are described in U.S. Pat. No. 4,836,084, disclosing an armor plate composite including a supporting plate consisting of an open honeycomb structure of aluminum, and U.S. Pat. No. 4,868,040, disclosing an antiballistic composite armor including a shock-absorbing layer. Also of interest is U.S. Pat. No. 4,529,640, disclosing spaced armor including a hexagonal honeycomb core member. Each of these patents is incorporated herein in its entirety.

In U.S. Pat. Nos. 3,523,057 and 5,134,725, ceramic spheres are incorporated into a soft matrix; however, the matrix is of a flexible nature, and no additional material is incorporated in the device. In addition, in U.S. Pat. No. 5,134,725 indicates that the spherical pellets are not in a close-packed arrangements, which limits the transfer of energy within a same layer. Other patents, such as U.S. Pat. No. 6,112,635, 6,289,781 and 6,408,734 describe single-layered pellet arrays packed within a matrix. However, the number of near neighbor pellets is limited in this design, and the scattering effect induced by the pellets is not as efficient as a spherical scattering. Each of these patents is also incorporated herein by reference.

### SUMMARY OF THE INVENTION

Embodiments of the present invention overcome and/or otherwise address the above identified and other disadvantages of prior ceramic armors and other types of existing art armors, and provide protection against various armor-piercing and highly energetic threats by redirecting and redistributing the kinetic energy and momentum of the threat via metal and composite bodies for deployment in composite armor panels, in a manner that is effective against armor-piercing, high-velocity projectiles, Improvised Explosive Devices (IEDs), and other damaging devices that can penetrate the hulls of armored vehicles.

According to various exemplary embodiments, the armor of various embodiments of the present invention includes several layers of metal alloys and may optionally include at least one layer of a composite or other flexible material. One of the metal alloy layers may be in the form of a truss, and the composite layer may comprise Aramid fiber, for example. In one exemplary embodiment, the various metal alloys may be high hardness aluminum alloys, such as Al 2025, and high hardness steels, such as AR500. Additionally, a high hardness layer, such as a layer comprising Tungsten, may be added to the armor to blunt or distribute energy of the projectile.

One aspect of various embodiments of the present invention involves consideration of the Hardness-Plasticity Gradient (HPG) across the thickness of the armor, starting from the outside of the armor and extending inside the armor. For example, in some embodiments, starting from the outside of the armor, which is the surface that typically receives the first impact of a projectile, the hardness of a layer or layers is selected to be greater and the plasticity lower than interior layer, with one or more subsequent interior layers exhibiting a hardness that is equal to or smaller than the preceding layer, with a plasticity that is equal to or greater than the preceding layer. Thus, a suitable HPG is realized for a particular application.

One role of the outside layer can be to blunt or shatter the projectile into multiple fragments to distribute the energy, perpendicular to the projectile path and over a greater portion of the plane of the exterior surface of the armor. In subsequent layers, the hardness of the inner layers also blunts or redistributes the energy of the projectile, but the increased plasticity of the inner layers, including one or more truss layers, allows these layers to absorb the kinetic energy of the projectile across the inner layers. Accordingly, the combination of the HPG and the truss provides a high protection against projectiles.

As noted, one of the layers that form the armor in accordance with embodiments of the present invention may include a structural truss that is less compact than the other layers and that combines the advantage of having one or more solid panels with an air gap. For example, the truss may absorb the kinetic energy of the projectile and distribute the energy laterally, rather than transmit the kinetic energy of the projectile radially to the subsequent layer, the lateral distribution of energy thereby preventing the projectile from penetrating the armor.

Another exemplary embodiment includes at least one layer of a composite material bounded by a structural plate or plates. According to this exemplary embodiment, the outermost layer of the armor comprises a high hardness material, such as steel, high hardness aluminum, tungsten alloys, or any other material having similar properties to these materials. One role of the outside layer is, for example, to blunt or shatter the projectile into multiple fragments to distribute the energy within the plane of the exterior surface of the armor. The outermost layer may also provide protection to the subsequent layers against multiple event damage.

In another exemplary embodiment, the second layer includes a composite material made of a plurality of tightly nested layers in a self-assembling arrangement of spheres made of a high hardness material, such as ceramic, bonded together using a lower stiffness, castable matrix material, such as a polymer resin, low grade ceramic material, or an aluminum alloy. The final layer may include a high hardness material for protection and support. A fibrous composite is affixed to the final layer of the high hardness material, but may be omitted in other embodiments of the present invention. There also may be an air gap between the armor and the base vehicle body.

Among other advantages, the present invention presents protection against both the projectile and the blast wave generated by the explosion.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a side representative view of layers of exemplary armor components armor, according to an embodiment of the present invention;

FIGS. 2A-2B illustrate two variations of features in an outside layer of the armor, according to an embodiment of the present invention;

FIG. 3 illustrates a side view of another exemplary embodiment of armor in accordance with the present invention; and

FIG. 4 illustrates side view of yet another exemplary embodiment of armor in accordance with the present invention.

### DETAILED DESCRIPTION OF THE INVENTION

Embodiments of the present invention will now be described more fully hereinafter with reference to the accompanying drawings, in which exemplary embodiments of the invention are shown. Embodiments of the present invention may, however, be embodied in different forms and should not be construed as limited to the embodiments set forth herein. Rather, these embodiments are provided so that this disclosure will be more clearly understood through examples, and will therefore fully convey the scope of various embodiments of the present invention to those skilled in the art. In the figures, the dimensions of layers and regions may be exaggerated for clarity of illustration. Like reference characters refer to like elements throughout.

It is first noted that one test for assisting in design of the exemplary armor of the present invention is to submit the armor to a 0.50 caliber or a 20 mm Fragment Simulated Projectile (FSP) launched at the armor at a high velocity one to four times in a row. In the subsequent description, reference will be made to the FSP; however, embodiments of the present invention also encompass any other type of projectile.

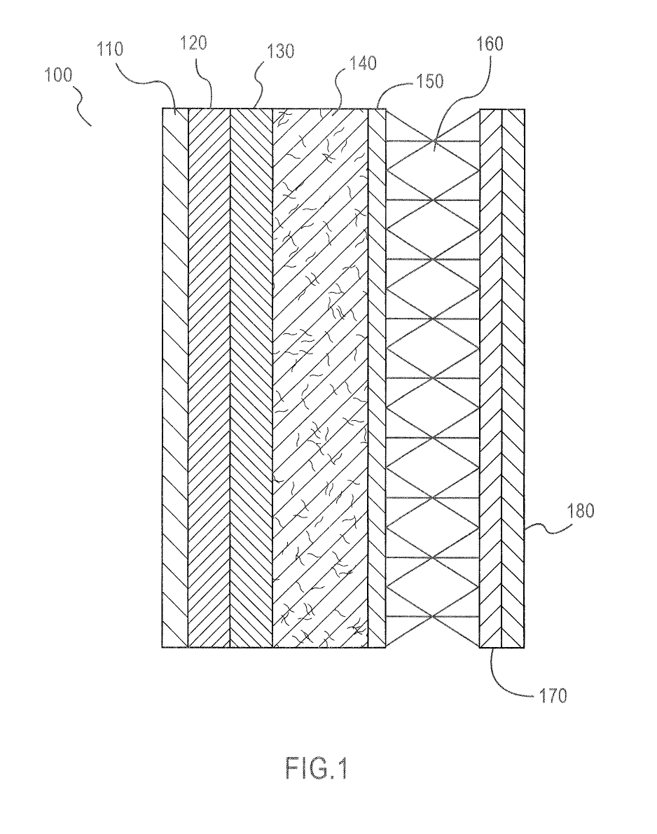

FIG. 1 illustrates a side view of exemplary armor 100, according to an embodiment of the present invention. In the exemplary embodiment illustrated in FIG. 1, the outside layer 110 is the first layer to receive the impact of the FSP, and one role of the outside layer 110 is to blunt the FSP, shatter the FSP into multiple fragments, and/or redistribute the force of the FSP, so that the kinetic energy of the FSP is distributed for more effective absorption. The outside layer 110 may comprise a high hardness and low plasticity material, such as Tungsten. Other materials with similar or otherwise suitable combination of hardness and plasticity may also be used as the outside layer 110. Underneath the outside layer 110 is a layer 120, which may have a hardness that is equal to or smaller than the outside layer 110, and a plasticity that is equal to or greater than the outside layer 110. Accordingly, the layer 120 may have better deformation characteristics and be capable of absorbing more kinetic energy communicated by a projectile, such as an FSP, than the outside layer 110. The layer 120 may increase the absorption of the kinetic energy communicated by the FSP and exhibit a greater impact deformation compared to the outside layer 110. The layer 120 may comprise a high-hardness steel, such as, AR500, or any other material with a similar or otherwise suitable combination of hardness and plasticity. It should be noted that, for use in applications involving smaller caliber projectiles, the outside layer 110 may be omitted from the armor 100.

Underneath the layer 120, there may be another layer 130, which may be made of a material having a hardness that is equal to or smaller than the layer 120, and a plasticity that is equal to or greater than the outside layer 120. The layer 130 may comprise, for example, a high-hardness aluminum alloy, such as Al 2025, or any other metal or alloy exhibiting a similar or otherwise suitable combination of hardness and plasticity. The layer 130 provides additional absorption of the kinetic energy communicated by the FSP, and also in blunting the impact of the FSP. The layer 130 also exhibits greater energy absorption and impact deformation, compared to the layer 120. Underneath the layer 130, there may be a composite or other suitable material layer 140, such as an Aramid fiber layer, that comprises a more absorptive material than the layer 130. The composite layer 140 of this embodiment is selected to provide a high degree of energy absorption and dissipative characteristics, in that the kinetic energy communicated by the FSP is not only absorbed by this layer 140, but also dissipated laterally across the surface area and volume of the layer 140. The layer 140 exhibits the least hardness of all the layers 110-130, and the greatest plasticity or deformation, as well as the greatest energy absorption of all the layers 110-130. Accordingly, starting from the outside layer 110 to the composite layer 140, a suitable HGP for certain impact applications may be realized, in that hardness gradually decreases and plasticity gradually increases from the outside layer 110 to the composite layer 140.

Underneath the composite layer 140, there may be a truss layer comprising portions 150, 160 and 170. According to various exemplary embodiments, layer portion 150 provides a rigid interface for the truss layer 150, 160, 170, which is underneath the layer 150. For example, if the layer 130 comprises high strength aluminum, then the layer portion 150 may also comprise high strength aluminum. Similarly, the layer portion 170, located on the other side of the layer portion 150 from the truss structure portion 160, also provides the truss layer 150, 160, 170 with a rigid interface to ensure that the truss structure portion 160 is firmly situated between the two layers 150 and 170. It should be noted that the layer portion 170 may be similar in nature and size to the layer portion 150, because both layers fulfill a similar role in enabling the truss layer 150, 160, 170 to provide a rigid interface. In one embodiment, both layer portions 150 and 170 are relatively soft metals that provide plasticity to distribute the kinetic energy communicated by the FSP across the surface area of the layers and take advantage of the absorptive and distributive characteristics of the truss structure portion 160.

According to various exemplary embodiments, the truss layer 150, 160, 170 includes an air gap, and thus combines the advantage of a rigid surface, via the interfaces of layer portions 150 and 170 to further blunt or shatter the FSP, with capability to dissipate kinetic energy laterally or the impact communicated by the FSP through the truss layer 150, 160, 170. The truss structure portion 160 absorbs energy partly through the plastic deformation of its structural members and distributes the kinetic energy of the FSP laterally relative to the direction of impact of the FSP.

It should be noted that the more the kinetic energy of the FSP is dissipated laterally across the surface of the layers, the less energy is communicated to the structure underneath the armor (e.g., vehicle), and thus the less damage is imparted to the structure underneath the armor. Underneath the layer 170, there may be another high-hardness layer 180 similar to, for example, layer 120, which provides a backing layer that deflects any fragments of the FSP that may have penetrated the truss layer 150, 160, 170, in order to protect the underneath structure. It should be noted that the layer 180 also provides structural support for all the layers above it, given the weight of all the layers.

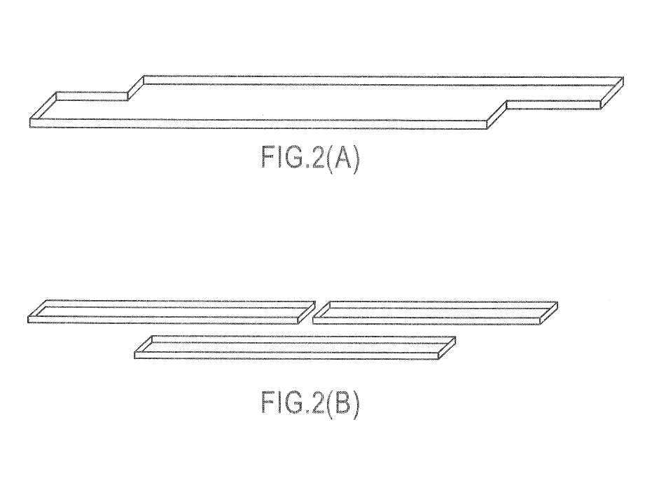

FIGS. 2A-2B illustrate two variations of an outside layer of the armor according to embodiments of the present invention. As discussed above, the possible roles of the outside layer include blunting the FSP, shattering the projectile into multiple fragments, and distributing energy. The two embodiments of FIGS. 2A-2B illustrate plates of the outside layer, comprising Tungsten, for example, that are assembled to provide the outer layer of the armor. Because high hardness layers, such as layers comprising Tungsten, are difficult to form, the outside layer may be formed of a number of smaller plates brought together and bonded or otherwise connected to each other laterally, so as to form the overall outside layer.

It should be noted that although the above description illustrates a specific number of layers and specific types of materials and alloys, embodiments of the present invention also encompass any other similarly layered armor, as long as there is a suitable HPG, such as where the hardness of the outermost layer of the armor decreases in the inner layers, and the plasticity of the outmost layer increases in the inner layers. Thus, other layered armors with a different number of layers, with different materials, and with different thicknesses also fall within the scope of the invention, if the HPG is similarly applicable for the armor structure.

Although the above discussion focused on armored vehicles, the disclosed armor can also be applied to other structures, such as ship hulls, buildings, and the like. It should also be noted that the above-disclosed armor can be fully integrated in the design and manufacture of the vehicle, or can be manufactured separately and then placed as an appliqué on a vehicle, ship hull, building, or the like.

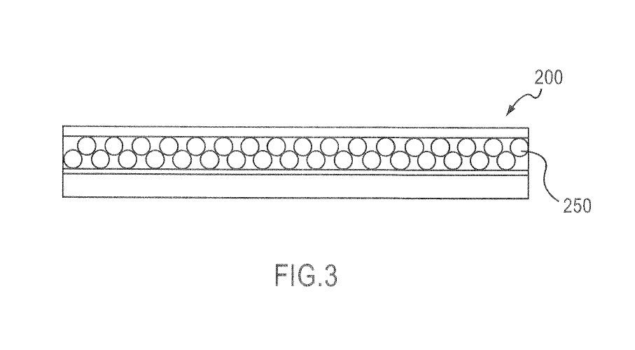

FIG. 3 illustrates a side view of another exemplary embodiment of armor layers 200, in accordance with embodiments of the present invention. The composite armor layers 200 illustrated in FIG. 3 perform multiple functions. The armor layers 200 redistribute the kinetic energy via elastic scattering, with the tightly nested spheres 250 propagating the energy and momentum from the impact location laterally along the armor layers 200 through collisions with neighboring spheres 250. The spheres 250 redirect projectiles that penetrate the outermost armor layer 200 via successive inelastic collisions, which dissipates energy and momentum from the projectile. Due to their spherical shape, it is highly unlikely that the spheres 250 can be impacted by the projectile so as not to deflect the initial trajectory of the projectile.

Furthermore, the composite material that is part of the armor layers 200 disperses and attenuates the blast wave that results from an explosion. The shape and distribution of the spheres 250 results in the scattering of the blast wave, and the spheres 250 act as scattering centers. For example, by using materials that have very different Young's moduli, it is possible to introduce distortions in the blast wave front. Furthermore, by optimizing the radius of the spheres 250 relative to the range of threats likely to be encountered, the spheres 250 thus may transform an impinging plane wave into a spherical wave, thus attenuating the energy density of the blast wave incident on subsequent layers of the armor and/or vehicle surface, which lessens the potential for damage. Multiple sets of composite layers 200 of varying composition may be employed.

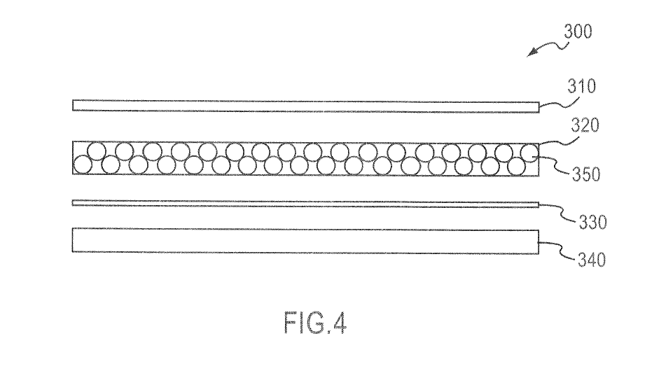

FIG. 4 illustrates a side view of another exemplary embodiment of armor layers 300, in accordance with embodiments of the present invention. In FIG. 4, the outside layer 310 is the first layer to receive the impact of the FSP, and blunts and/or shatters the FSP into multiple fragments, thus redistributing the energy and momentum of the FSP over a larger area of subsequent armor layers and/or vehicle surface. The outside layer 310 also provides the capability of withstanding multiple hits to the armor and protects the brittle components in, for example, underlying layer 320, from premature damage. The outside layer 310 may comprise a high hardness and low plasticity material, such as high-hardness steel or tungsten. Other materials with similar or otherwise suitable combinations of hardness and plasticity may also be used as the outside layer 310.

Underneath layer 310, layer 320 comprises several portions. One portion includes spheres 350 made of, for example, alumina, ceramics, or hard and high melting point materials arranged in a close-packed configuration. For example, the spheres 350 contained in layer 320 may be one-inch diameter spheres, but may have varying sizes for varying levels of protection. The spheres 350 may be embedded in a matrix comprising a casting material, such as a polymer resin, or a metal, such as aluminum. It should be noted that the various materials included in the layer 320 are selected to create an impedance mismatch between the high-hardness, elastic and inelastic scattering centers, and the compressive suspension matrix, in order to minimize the momentum and kinetic energy transfer at the impact point, among other things. The arrangement of the components in the layer 320 is such that they allow for improved momentum and energy transfer throughout the layer 320. For example, as a sphere 350 is impacted by a projectile, it is deflected into adjacent spheres 350, and the energy and momentum of the projectile are transferred from the point of impact to the other spheres 350 and dispersed. As the energy disperses, the penetration of the projectile inside the armor layers 300 is decreased.

For example, the shape of the embedded spheres may help in mitigating projectile penetration by increasing the likelihood of deflection of a projectile from the projectile's initial path, which makes the projectile travel a longer path through the armor, and thus dissipates more energy. By using small discrete spherical units 350 within the layer 320, the ability of the layer 320 to withstand multiple hits is improved. Furthermore, the array of spheres 350 within the composite layer 320 provides enhanced protection against the shock wave generated by many high-energy weapons. For certain types of threats, the large shock wave produced can be more damaging than the actual projectile. The arrangement of the spheres 350 within the composite layer 320 disperses the plane wave associated with a high-energy blast. As the shock wave impacts the composite, the wave is transformed from a plane wave incident upon a small area, into a spherical wave incident upon a larger area, which results in the dissipation and the dispersion of the wave front, thus lessening the wave's potential for destruction.

In addition to the physical destruction arising from a projectile impact, the impact of a highly energetic plane wave on armor can cause extreme compression and heating of the armor layers 300. In order to deal with this problem, the materials that comprise the armor layers 300 may have a high hardness and a high melting point to mitigate the damage of the plane wave. According to an exemplary embodiment of the present invention, high hardness and high melting point materials are incorporated at least into the composite structure, and may be incorporated into other layers within the armor layers 300. The size of the spheres 350 may be optimized with respect to the specific application and the type of expected threat, in order to maximize the scattering of the blast wave and the projectile.

Underneath the layer 320, another layer 330 is provided, which comprises a material similar to the materials in layer 310, but that may also comprise softer materials. Layer 330 acts as a solid backing to layer 320 and helps in the dispersal of energy by channeling energy and momentum away from the vehicle beneath and back into layer 320. Layer 330 also provides a rigid interface with layer 340, which comprises a ballistic fiber composite made of polyethylene or Aramid fibers. These materials in layer 340 are energy absorbent. Underneath layer 340, an air gap may be present between the vehicle and the armor layers 300.

According to various exemplary embodiments, the layers 110 to 180, 200, and 300 shown in FIGS. 1, 3, and 4, respectively, may be bonded or otherwise connected to each other via such features as welding, hanging, gluing, sealing, caging, strapping, soldering, bolting, or the like. From a manufacturing standpoint, the various layers may be manufactured separately and brought together via bonding or other connection. It should be noted that the truss layer 150, 160, 170 in FIG. 1, for example, may be manufactured by producing the two layer portions 150 and 170 separately, producing the truss portion 160, and then assembling the three layers 150, 160, 170.

An exemplary embodiment of the various approximate thicknesses of the layers 110-180 of FIG. 1 or 310-340 of FIG. 4, in accordance with one variation of the present invention, is as follows: layer 110: 0.125 in., layer 120: 0.25 in., layer 130: 0.25 in., layer 140: 1.0 in., layer portion 150: 0.0625 in., layer portion 160: 1.0 in., layer portion 170: 0.125 in., and layer 180: 0.125 in. It should be noted that the thickness of layer 110 may also be about 0.2 in. It should also be noted that the various thicknesses illustrated here are examples only, and may be varied to optimize the protective properties of the armor layers 100 and 300 (of FIGS. 1 and 4, respectively), such as for particular applications. Furthermore, although the armor layers 100 of FIGS. 1 and 300 of FIG. 4 are illustrated as having eight layers and four layers, respectively, this number is an example only, and the number of layers used in the armor layers 100 and 300 may be varied and optimized to maximize or otherwise vary the protective properties of the armor layers 100 and 300.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. Multilayer armor, comprising:
an outside armor layer;
a first armor layer underneath the outside armor layer;
a second armor layer underneath the first armor layer; and
a truss layer underneath the second armor layer.

2. The multilayer armor of claim 1, wherein the outside armor layer comprises at least one selected from a group consisting of tungsten and high hardness steel.

3. The multilayer armor of claim 1, further comprising:
a third layer between the outside armor layer and the first armor layer.

4. The multilayer armor of claim 3, wherein the third layer comprises steel.

5. The multilayer armor of claim 1, wherein the first armor layer comprises aluminum.

6. The multilayer armor of claim 1, wherein the second armor layer comprises one selected from a group consisting of a composite and Aramid fiber.

7. The multilayer armor of claim 1, wherein the multilayer armor has a hardness-plasticity gradient from the outside armor layer to the second armor layer, wherein the outside armor layer has the highest hardness and the lowest plasticity, and which each subsequent layer underneath the second armor layer has a lower hardness and a higher plasticity than the layer above.

8. The multilayer armor of claim 3, wherein a hardness-plasticity gradient exists from the outside armor layer to the second armor layer, wherein the outside armor layer has the highest hardness and the lowest plasticity, and wherein each subsequent layer underneath the second armor layer has a lower hardness and a higher plasticity that the layer above it.

9. The multilayer armor of claim 1, wherein the truss layer comprises an outer rigid layer, a truss structure, and an inner rigid layer.

10. The multilayer armor of claim 9, wherein the outer rigid layer and the inner rigid layer comprise high strength aluminum.

11. The multilayer armor of claim 1, wherein the outside armor layer, the first armor layer, the second armor layer, and the truss layer are bonded together.

12. The multilayer armor of claim 3, wherein the outside armor layer, the optional armor layer, the first armor layer, the second armor layer, and the truss layer are bonded together.

13. The multilayer armor of claim 1, wherein one or more planar portions of the outside armor layer, the first armor layer, the second armor layer, and the truss layer are distributed over a surface of a vehicle body.

14. The multilayer armor of claim 3, wherein one or more planar portions of the outside armor layer, the optional layer, the first armor layer, the second armor layer, and the truss layer are distributed over a surface of a vehicle body.

15. Multilayer armor, comprising:
an outside armor layer;
a composite layer underneath the outside armor layer that includes a plurality of spheres;
a second armor layer underneath the composite layer to provide a rigid support to the composite layer; and
a third armor layer underneath the second armor layer.

16. The multilayer armor of claim 15, wherein the outside armor layer comprises at least one selected from a group consisting of tungsten, high hardness steel, and aluminum.

17. The multilayer armor of claim 15, wherein the plurality of spheres comprise at least one selected from a group consisting of alumina, ceramics, and high-strength steel.

18. The multilayer armor of claim 15, wherein the plurality of spheres are embedded in a matrix.

19. The multilayer armor of claim 18, wherein the matrix comprises at least one selected from a group consisting of a polymer resin, a metal, and a casting material.

20. The multilayer armor of claim 19, wherein an impedance mismatch exists between components in the composite layer.

21. The multilayer armor of claim 15, wherein at least one layer of the multilayer armor has a high melting point and high hardness.

22. The multilayer armor of claim 15, wherein the third armor layer comprises a ballistic fiber composite.

23. The multilayer armor of claim 22, wherein the ballistic fiber composite comprises at least one selected from a group consisting of polytethylene and Aramid fibers.

24. The multilayer armor of claim 15, further comprising:
an air gap underneath the third armor layer.

25. The multilayer armor of claim 15, wherein the outside armor layer, the composite layer, the second armor layer, and the third armor layer are bonded together.

26. The multilayer armor of claim 15, wherein one or more planar portions of the outside armor layer, the composite layer, the second armor layer, and the third armor layer are distributed over a surface of a vehicle body.

27. A method of manufacturing a multilayer armor, comprising:
applying a truss layer to a vehicle;
applying a first armor layer to the truss layer;
applying a second armor layer to the first armor layer; and
applying an outside armor layer.

28. The method of claim 27, further comprising:
applying a third layer between the outside armor layer and the second armor layer.

29. The method of claim 27, further comprising:
bonding the outside armor layer, the first armor layer, the second armor layer, and the truss layer together.

30. The method of claim 28, further comprising:
bonding the outside armor layer, the third layer, the first armor layer, the second armor layer, and the truss layer together.

31. The method of claim 27, further comprising:
distributing one or more planar portions of the outside armor layer, the first armor layer, the second armor layer, and the truss layer over a surface of the vehicle.

32. The method of claim 28, further comprising:
distributing one or more planar portions of the outside armor layer, the third layer, the first armor layer, the second armor layer, and the truss layer over a surface of the vehicle.

33. A method of manufacturing multilayer armor, comprising:
providing an outside armor layer;
providing a composite layer underneath the outside armor layer that comprises a plurality of spheres;
providing a second armor layer underneath the composite layer to provide a rigid support to the composite layer; and
providing a third armor layer underneath the second armor layer.

34. The method of claim 33, further comprising:
embedding the plurality of spheres in a matrix.

35. The method of claim 33, further comprising:
bonding the outside armor layer, the composite layer, the second armor layer, and the third armor layer together.

36. The method of claim 33, further comprising:
distributing the outside armor layer, the composite layer, the second armor layer and the third armor layer, over a surface of a vehicle body.
